(19) United States
(12) Patent Application Publication
(10) Pub. No.: US 2026/0009883 A1
(43) Pub. Date: Jan. 8, 2026

(54) OBJECT SIMULATOR FOR A SENSOR FOR OBJECT DETECTION, AND METHOD FOR SIMULATING AN OBJECT

(71) Applicant: dSPACE GmbH, Paderborn (DE)

(72) Inventor: Tim FISCH, Paderborn (DE)

(73) Assignee: dSPACE GmbH, Paderborn (DE)

(21) Appl. No.: 19/256,506

(22) Filed: Jul. 1, 2025

(30) Foreign Application Priority Data
Jul. 3, 2024 (DE) 102024118902.9

(51) Int. Cl. G01S 7/40; G01S 7/497

(52) U.S. Cl. CPC G01S 7/4095; G01S 7/497

(57) ABSTRACT

An object simulator for a sensor for object detection. A receiver is configured to receive a first signal emitted by the sensor and to output a first operating signal that is a function of the first signal. An analysis unit is configured to analyze the first operating signal and to determine at least one parameter of the first signal. A transmitter is configured to generate and send a second signal as a function of the at least one parameter and as a function of at least one object to be simulated. The second signal is provided for the reception by the sensor and is designed such that it is perceivable by the sensor as a reflection of the first signal on the at least one object to be simulated. A method for simulating an object for a sensor for object detection is also provided.

This nonprovisional application claims priority under 35 U.S.C. § 119(a) to German Patent Application No. 10 2024 118 902.9, which was filed in Germany on Jul. 3, 2024, and which is herein incorporated by reference.

### BACKGROUND OF THE INVENTION

### Field of the Invention

The present patent application relates to an object simulator for a sensor for object detection, and to a method for simulating an object for a sensor for object detection.

### Description of the Background Art

A sensor for object detection may be designed, for example, as a vehicle sensor that operates with electromagnetic waves. Examples of such vehicle sensors are radar sensors or lidar sensors. An object simulator for a sensor for object detection may be used, for example, during testing of such a vehicle sensor.

### SUMMARY OF THE INVENTION

It is therefore an object of the invention to provide a simulator for a sensor for object detection that can comprise a receiver that is configured to receive a first signal emitted by the sensor and to output a first operating signal that is a function of the first signal, an analysis unit that can be configured to analyze the first operating signal and to determine at least one parameter of the first signal, a transmitter that can be configured to generate and send a second signal as a function of the at least one parameter and as a function of an object to be simulated. The second signal can be provided for the reception by the sensor, and is designed in such a way that it is perceivable by the sensor as a reflection of the first signal on the at least one object to be simulated.

A method for simulating an object for a sensor for object detection can comprise: receiving a first signal emitted by the sensor, and outputting a first operating signal that is a function of the first signal, analyzing the first operating signal and determining at least one parameter of the first signal, generating a second signal as a function of the at least one parameter and as a function of at least one object to be simulated, and sending the second signal. Whereby, the second signal can be provided for the reception by the sensor, and is designed in such a way that it is perceivable by the sensor as a reflection of the first signal on the at least one object to be simulated.

The second signal can be designed in particular in such a way that it emulates a reflection of the first signal on the object to be simulated.

The object simulator allows sensors for object detection, such as a radar or lidar sensor, to be tested in the laboratory in various test scenarios. This saves on test drives of vehicles that include the sensor. For this purpose, the object simulator may be situated in a test setup via which the surroundings of the sensor and/or of the vehicle may be simulated. In the test environment, the object simulator in a virtual environment responds to the first signals emitted by the sensor, and thus acts as a real environment for the sensor.

By use of the object simulator and the method for simulating an object for a sensor for object detection, during the simulation it is possible for the analysis unit to determine at least one parameter of the signal emitted by the sensor. Such a parameter is preferably a modulation parameter. Thus, it is no longer necessary to determine such a parameter prior to the simulation, and greater efficiency can be achieved. In addition, the determination of the parameter may optionally be automated. Manual measurement of the signal may be dispensed with, which may result in cost savings.

The object simulator can be, for example, a device that includes the following components: a receiver for the first signal, a signal processor, including the analysis unit and an object generator, for the received signal, and a transmitter for sending the second signal, wherein the second signal emulates a reflection on the object to be simulated.

An object generator may be provided which changes the first operating signal to a second operating signal by manipulating the first operating signal. Changing the first operating signal to the second operating signal preferably takes place in such a way that the second signal, generated from the second operating signal, is perceived by the sensor for object detection as the described reflection on the at least one object.

If the sensor is a radar sensor, the receiver and the transmitter each can have a high-frequency component which in each case converts the first signal into an intermediate frequency for the first operating signal, and optionally converts the second operating signal into the second signal on a transmission frequency range that is in the high-frequency range. The second operating signal is also in the range of the intermediate frequency. The high-frequency range for the first and second signals is higher than the intermediate frequency range. The intermediate frequency range is in the so-called baseband, for example, but may also be in a higher frequency range than the baseband.

The first signal may include, for example, the emitted clock signal of the sensor, for example a radar sensor. The clock signal is modulated. The first and second operating signals, as described, are in a different frequency range than the first and second signals. The operating signals themselves may be modulated, for example in the same way as for the first and second signals.

The object detection by the sensor for object detection takes place using the emitted first signal, for example the clock signal of the sensor, and the received second signal. The second signal is perceived by the sensor as a reflection on an object. The object detection may then be carried out by the sensor by evaluation of the first and second signals. The object detection may encompass, for example, determination of the location of the object as well as the movement of the object, i.e., its speed, its acceleration, and the direction of the movement. This may also involve the size of the object, which in the case of the radar sensor may be determined as a function of a radar cross section, for example.

The analysis unit can have an estimator, for example, which, based on the first operating signal, estimates at least one parameter of the first signal. The analysis unit may have digital and/or analog components for this purpose. The analysis unit may include software and/or hardware. For example, analog or digital low pass filtering, analog-digital conversion, and digital or analog determination of the at least one modulation parameter may be provided for estimating at least one modulation parameter as the at least one parameter. A field-programmable gate array (FPGA) and/or a processor may be used for the digital determination. In particular, stepwise estimation of the at least one modulation parameter may take place. The FPGA may initially check for certain modulation processes, and the at least one modulation parameter for the identified modulation process may be subsequently determined by the processor, for example. If a frequency modulation continuous wave (FMCW) modulation process is used with the radar, the FPGA may monitor the occurrence of a “chirp,” and the FMCW modulation parameters may then be determined by the processor and/or the FPGA, using the chirp. This may involve, for example, the steepness of the chirp, i.e., the period of time over which the chirp runs at a particular frequency, the frequency span, and/or the repetition rate of the chirp.

An analog design of the analysis unit may provide the advantage of cost savings, since analog-digital converters may be dispensed with here. In particular, high-quality analog-digital converters with a high sampling rate and low latency may be costly.

In addition, the analysis time may likely be shortened with an analog design.

The object simulator adds to the first signal an appropriate signal that this/these object(s) would cause due to the reflection or refraction arising therefrom, corresponding to the number, the movement, and optionally the shape of the objects to be simulated. Thus, the object or the objects is/are emulated. The second signal is sent from the transmitter.

By use of the object simulation, sensors such as radar may be virtually tested for various scenarios, using a plurality of objects, without having to provide a complex test setup. In addition, functions for detecting the objects may thus be tested. It is also possible to test how a vehicle can be guided in response to the detection when it is driven semiautomatically or fully automatically, for example.

The object simulator and of the method, the first and second signals each can have a high-frequency signal in the microwave range. This may apply in particular for use of the sensor as a radar sensor. The microwave range refers, for example, to electromagnetic waves that propagate at a frequency of 1 to 300 GHz.

The first signal can be frequency-modulated, and the at least one parameter pertains to the modulation of the first signal. For a radar signal, a frequency modulation such as FMCW, i.e., continuous-wave radar, is possible. The first signal, which has a constant amplitude, for example, and periodically runs through a frequency range, is emitted as a clock signal. Running through this frequency range is referred to as a “chirp.” At least two chirps may directly adjoin one another, or a pause may be provided between them.

The analysis unit can be configured to determine at least one modulation parameter of the first signal, wherein the at least one modulation parameter has a central frequency, a frequency range, a slope, a ramp duration, a ramp number, a frame duration, and/or a repetition rate. These are modulation parameters that may occur in particular with FMCW modulation. In an example of the method, the analysis of the first signal includes determining the described at least one modulation parameter of the first signal.

For the ramp of a chirp, the central frequency is the average frequency of the frequency range about which the chirp runs. The frequency range can be the frequency that is passed through by the chirp during a ramp passage. The slope is the frequency range divided by the time for which a chirp lasts. The time for which a chirp lasts is referred to here as the ramp duration. The ramp number denotes the number of chirps that are passed through per frame. The frame duration is the time for which a frame lasts. The repetition rate may denote the frequency of the frames, but also the frequency of the chirps. A frame corresponds to one clock signal.

The analysis unitc can include an analog circuit for analyzing the first operating signal and/or for determining the at least one parameter. An analog circuit can be understood to mean, for example, low pass filtering and/or analog-digital conversion and/or other filter circuits for parameter estimation, and/or an analog computer.

The analysis unit can be configured to determine the at least one parameter using a spectrogram and/or using artificial intelligence. When artificial intelligence is used, it may be trained beforehand on the modulation process used, in order to then identify the corresponding modulation parameters from the first operating signal. Neural networks which can be implemented on appropriate processors such as graphics processors may be used for artificial intelligence. Accordingly, in an example of the method the analysis takes place using a spectrogram and/or artificial intelligence.

The analysis unit can include at least one gate array, for example a field-programmable gate array (FPGA). Such programmable gate arrays allow a flexible design and rapid execution.

The object generator can be configured to change the first operating signal with regard to a phase, an amplitude, and/or a frequency, and to output it as the second operating signal. Similarly, in an example of the method the changing of the first operating signal to the second operating signal takes place with regard to the phase, the amplitude, and/or the frequency.

The object generator can be configured to change the first operating signal with regard to an amplitude, and to output it as the second operating signal. Alternatively or additionally, the carrier signal generator is configured to generate a second carrier signal which with regard to a phase and/or a frequency emulates the object to be simulated. The second signal is then generated from the second operating signal and the second carrier signal, and sent as the second signal. Similarly, the second signal then emulates the reflection on the object to be simulated.

The receiver can be configured to link the first signal to a first carrier signal for the first operating signal, and the transmitter is configured to link the second operating signal to a second carrier signal for the second signal. The generation of the second carrier signal may be based on the at least one parameter that is determined by the analysis unit, and optionally, also on the object to be simulated. Thus, using the modulation parameters that are determined by the analysis unit, the second carrier signal may be determined in such a way that the second signal may be sent, provided with the correct modulation parameters. The linkage to the corresponding carrier signals may be carried out, for example, by appropriate mixers, and may involve a heterodyne principle, for example. Nonlinear components such as diodes or transistors may also be used as mixers. Correspondingly, in examples of the method, the reception of the first signal and the sending of the second signal may take place.

The emulation of the object to be simulated may thus optionally be carried out by the object generator and/or the carrier signal generator.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 schematically shows a test setup,

FIG. 2 schematically shows a block diagram of an example of an object simulator,

FIG. 3 schematically shows a block diagram of an example of the object simulator,

FIG. 4 schematically shows a block diagram of an example of an object simulator,

FIG. 5 shows a frequency-time diagram for schematically illustrating chirps, and

FIG. 6 schematically shows a flow chart of a method for simulating an object for a sensor for object detection.

### DETAILED DESCRIPTION

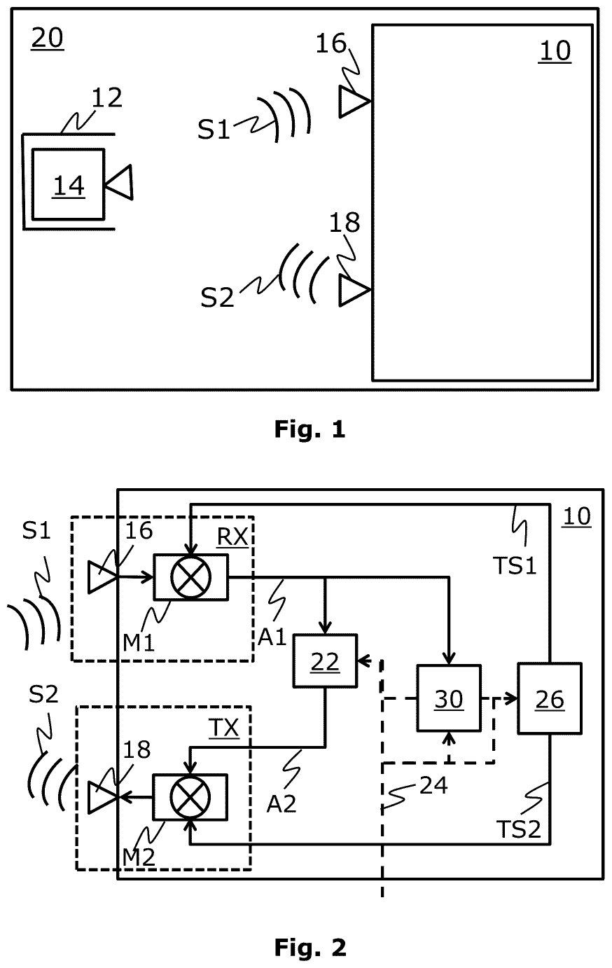

FIG. 1 shows a test setup 20 with an object simulator 10 that simulates at least one object for a sensor 14 for object detection. The sensor 14 is situated in a receptacle 12. The receptacle 12 may hold the sensor 14 in a predefined space for testing using the object simulator 10, or the receptacle 12 is mounted on a vehicle and holds the sensor 14 at its intended position. The receptacle 12 indicates the location at which the sensor 14 may be situated in the test setup 20 for carrying out tests. As illustrated in FIG. 1, the receptacle 12 may be designed as an enclosure that at least partially surrounds the sensor 14. The receptacle 12 may also have some other design, and, for example, may simply spatially indicate the location inside the test setup 20 where the sensor 14 may be positioned.

The sensor 14 may include a radar unit. The receptacle 12 may be made of plastic, metal, and/or other materials. In addition, the receptacle 12 may also have electrical interfaces for connecting the sensor 14 for operation thereof.

The sensor 14 emits a first signal S1, for example in the form of a clock signal, which is received by the object simulator 10 via its first antenna 16. If the sensor 14 is designed as a radar sensor, the first antenna 16 may be designed to receive high-frequency signals.

The object simulator 10 converts the signal S1 into a first operating signal A1. For sensors 14 that operate using electromagnetic waves, for example radar, the frequency of this first operating signal A1 is less than the frequency of the first signal S1. The first operating signal A1 on the one hand is supplied to an analysis unit 30, 32, 34, which extracts from the first operating signal A1 at least one parameter that characterizes the modulation process of the first signal S1. On the other hand, the first operating signal A1 is supplied to an object generator 22, which manipulates the first operating signal A1 and converts it into a second operating signal A2. The manipulation by the object generator 22 into the second operating signal A2 takes place in such a way that a reflection on at least one object is thus emulated. From the second operating signal A2, the object simulator 10 then generates, as a function of the at least one parameter, a second signal S2, which is sent via the second antenna 18. For sensors 14 that operate using electromagnetic waves, for example radar, the frequency of this second signal S2 is higher than the frequency of the second operating signal A2.

The object generator 22 may change the amplitude of the first operating signal A1, which emulates a property of the object to be simulated, namely, the so-called radar reflecting surface for a radar sensor (radar cross section (RCS)). Properties of the simulated object regarding the distance and the speed may alternatively or additionally be emulated by the mixing operation of the second operating signal A2 with the second carrier signal TS2. The second carrier signal TS2 may be set as a function of the parameters that are determined by the analysis of the first signal S1, and of the object properties to be simulated.

When a radar sensor is used as the sensor 14, the second antenna 18 is an antenna for sending high-frequency signals, for example a horn antenna, parabolic antenna, or patch antenna. In particular, the antennas 16 and 18 may also have a monostatic design. The antennas 16 and 18 are then designed as a single antenna.

The first and second antennas 16, 18 may also have a monostatic design. The first and second antennas 16, 18 are then the same antenna, which for the case of a radar sensor is connected to a circulator or coupler.

FIG. 2 schematically shows a block diagram of an example of the object simulator 10, which in the illustrated example simulates at least one object for a radar sensor as the sensor 14.

The first signal S1 is received by the first antenna 16. A first mixer M1 converts the first signal S1 into the first operating signal A1 via a linkage, for example a multiplicative linkage, of the first signal S1 to a first carrier signal TS1.

The first antenna 16 and the mixer M1 are components of a receiver RX. Even further components may be present, such as filters, for example band pass filters, and amplifiers, in order to handle the received first signal S1 for further processing.

The first mixer M1 has a diode or a transistor, for example, for the linkage. There may also be combinations of active and passive, or only active, electrical and electronic components. Use of a nonlinear characteristic curve, which includes a single component such as a diode or a transistor, or use of several of such and/or other components is advantageous.

The first mixer M1 is used for frequency conversion of the first signal S1 into an intermediate frequency, also referred to as an intermediate frequency range or intermediate frequency level. This conversion corresponds to the conversion into the first operating signal A1. For the illustrated example with a radar sensor as the sensor 14, the intermediate frequency is less than the frequency at which the first signal S1 is sent. The intermediate frequency may be in the so-called baseband, in which the lower edge is at 0 Hz or close to 0 Hz.

The first carrier signal TS1 is generated by a carrier signal generator 26, which may include a so-called local oscillator and/or a phase-locked loop (PLL), for example. The first mixer M1 includes one or more diodes and/or transistors, and carries out a multiplicative linkage of the first signal S1 to the first carrier signal TS1 for the first operating signal A1. Undesirable by-products of this mixing are subsequently filtered out by low pass or band pass filtering, for example. The first mixer M1 may also carry out the mixing in particular as complex mixing, for example using so-called IQ mixing.

The first operating signal A1 is transferred on the one hand to an object generator 22, and on the other hand to an analysis unit 30. The object generator 22 adds a change to the first operating signal A1, so that the resulting second operating signal A2 is such that it characterizes the reflection of the first signal S1 on the at least one object. This at least one object is simulated in this way. For FMCW radar, this is achieved via a frequency shift, for example. The second operating signal A2 is transferred from the object generator 22 to the transmitter TX, and thus to the second mixer M2.

The object generator 22 is optionally supplied from the outside with object information 24. Further object information not present in the object simulator 10 may thus be utilized to simulate the object, and optionally utilized by further objects, which allows flexibility. In particular, objects that are not already stored in the object simulator 10 may thus be simulated. The object generator 22 may optionally obtain information from the analysis unit 30 concerning the at least one determined parameter.

The analysis unit 30 extracts from the first operating signal A1 the at least one parameter, which is a modulation parameter, for example. For this determination of the at least one parameter, the analysis unit may optionally obtain information 24 from the outside concerning the object to be simulated.

For extraction of the at least one parameter, the analysis unit 30 includes a corresponding device, which may have a completely analog design. The analysis unit 30 may optionally also include digital components or may have a completely digital design. The analysis unit 30 transfers the at least one parameter to the carrier signal generator 26 and optionally to the object generator 22.

The carrier signal generator 26 generates at least the second carrier signal TS2 as a function of the at least one parameter that is received by the analysis unit 30. The second carrier signal TS2 is a local oscillator signal, for example a sinusoidal signal. The second carrier signal TS2 may optionally have been generated by the carrier signal generator 26 in such a way that it emulates certain properties of the object to be simulated. The carrier signal generator 26 transfers the second carrier signal TS2 to the second mixer M2 in the transmitter TX.

The second carrier signal may optionally also be manipulated by the carrier signal generator 26 in such a way that certain properties of the object to be simulated, for example distance and/or speed, are emulated by the manipulation, for example via a frequency shift. The carrier signal generator 26 may receive the object information 24 for this purpose.

The second mixer M2 multiplies the second operating signal A2 by the second carrier signal TS2. The second operating signal A2 is thus transformed into the high-frequency range in order to then send it as a second signal S2 to the sensor 14. The second mixer M2 has a design that is analogous to that of the first mixer M1. After the second mixer M2 the second signal S2 may optionally be filtered, for example using a band pass filter, and amplified. The second signal is then sent via the second antenna 18.

The second mixer M2, the second antenna 18, and optional further components, such as filters and amplifiers, form the transmitter TX. It is possible for the object simulator 10 to be situated in a housing, or to be distributed over multiple housings.

The carrier signal generator 26 may also influence the first carrier signal TS1 as a function of the at least one parameter, in particular if changing the frequency and/or the phase of the first carrier signal TS1 would result in an improved first operating signal A1.

It is also possible for the frequency shift to be implemented by the object generator 22. The frequency shift is dependent on the object to be simulated as well as the at least one determined parameter, and the distance between the sensor 14, i.e., the receptacle 12, and the object simulator 10. For the manipulation of the first operating signal A1 by a frequency shift, the object generator 22 obtains information concerning the at least one determined parameter, in particular the chirp parameters, from the analysis unit 30. In such an example, the second carrier signal TS2 may be equal to the first carrier signal TS1.

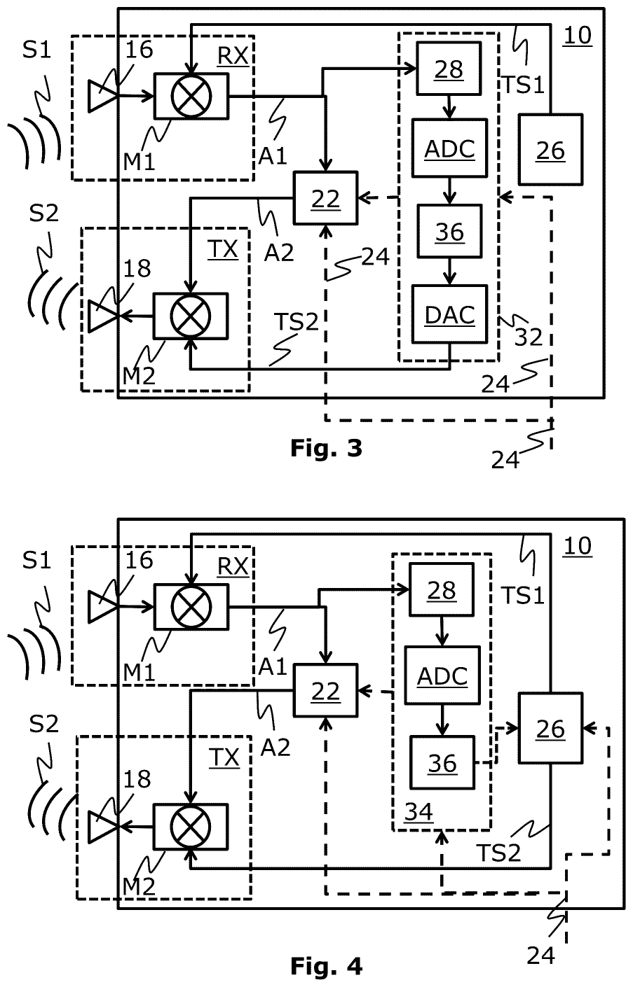

FIG. 3 schematically shows a block diagram of an example of the object simulator 10. Also in the example illustrated in FIG. 3, the object simulator 10 simulates at least one object for a radar sensor as the sensor 14. The same or similar components as in FIG. 2 are denoted by the same reference symbols.

FIG. 3 illustrates the design of the analysis unit 32. The first operating signal A1 is received by the analysis unit 32 via a filter 28. The filter 28 may in particular be a low pass filter that filters out undesirable mixing products that are still part of the first operating signal A1, as well as noise, so that, for example, the baseband portion in the subsequent component enters an analog-digital converter ADC. It is possible for this analog-digital converter ADC to carry out undersampling when the sampling rate is to be reduced. This reduces the hardware costs.

The digital data that are output by the analog-digital converter ADC are processed by a digital data processor 36 in order to extract the at least one parameter from the first operating signal A1. For this purpose, the digital data processor 36 may include an FPGA and/or one or more processors to carry out the extraction. It is possible that in a first stage the digital data processor 36 checks, in the case of the FMCW signal, whether a chirp has even been received. Only when this is affirmed is it possible, for example, for the further determination by the processor or processors to take place in order to extract the at least one parameter. This may save on computing power.

The digital data processor 36 then determines the second carrier signal TS2, using the at least one parameter. This second carrier signal TS2 is converted into an analog second carrier signal TS2 by a digital-analog converter DAC and transferred to the transmitter TX.

The analysis unit 32 may obtain information 24 concerning the object to be simulated for extraction of the at least one parameter and for generation of the second carrier signal. Certain properties, for example a frequency shift, of the object to be simulated may then be emulated in the second carrier signal TS2 by means of the analysis unit.

The object generator 22 may emulate the object to be simulated in particular by changing the amplitude of the first operating signal A1 and outputting it as the second operating signal A2. The object generator 22 may also optionally emulate further properties of the object to be simulated in the second operating signal A2. For this purpose, the object generator 22 may receive from the analysis unit 32 in particular information concerning the at least one parameter.

The remaining functions of the object simulator 10 may be carried out as described for FIG. 2.

FIG. 4 schematically shows a block diagram of an example of the object simulator 10. The analysis unit 34 includes the filter 28, the analog-digital converter ADC, and the digital data processor 36. The analysis unit 34 may optionally receive information 24 from the outside concerning the object to be simulated and use it for the analysis for determining the at least one parameter.

In contrast to FIG. 3, the second carrier signal TS2 is once again output by the carrier signal generator 26 (local oscillator) to the transmitter TX.

The digital data processor 36 sends, as a function of the at least one parameter, a control signal to the carrier signal generator 26 in order to generate the second carrier signal TS2 on this basis. Such a control signal may be designed, for example, as an analog control signal that is output, for example, via an analog output of the digital data processor 36. It is also possible to provide a digital-analog converter DAC. It is likewise possible for the local oscillator 26 to also be able to process a digital control signal.

The second carrier signal TS2 may also optionally be manipulated by the carrier signal generator 26 in such a way that certain properties of the object to be simulated, for example distance and/or speed, are emulated by the manipulation, for example via a frequency shift. The carrier signal generator 26 may receive the object information 24 for this purpose.

The object generator 22 may in particular emulate the object to be simulated by changing the amplitude of the first operating signal A1 and outputting it as the second operating signal A2. The object generator 22 may optionally also emulate further properties of the object to be simulated in the second operating signal A2. For this purpose, the object generator 22 may receive from the analysis unit 34 in particular information concerning the least one parameter.

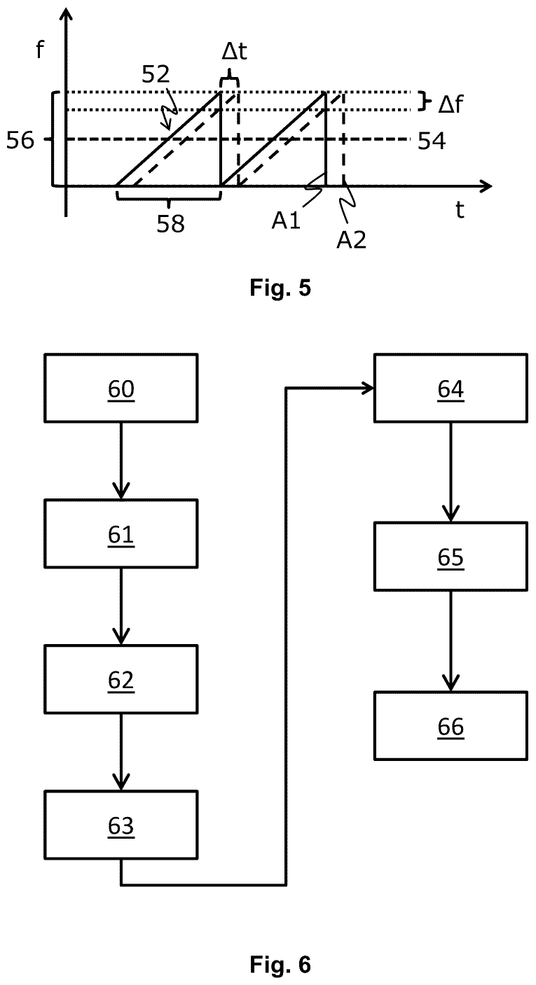

FIG. 5 shows a frequency-time diagram for illustrating chirps, which for an FMCW signal are used by a corresponding radar sensor, for example.

The time axis t is illustrated on the abscissa. The frequency f is shown on the ordinate. As an example, the first operating signal A1 is represented by a solid line and the second operating signal A2 is represented by a dashed line.

A time offset Δt and/or a frequency offset Δf between the operating signals A1 and A2 may be inserted by the object generator 22. The at least one simulated object is thus simulated; i.e., the result is the simulated reflection of the first signal S1 on the at least one simulated object. The illustrated chirps have the slope 52, the ramp duration 58, the central frequency 54, and the frequency range 56 that is passed through.

When the object is simulated via the frequency offset Δf, for example, it may be provided to compensate for, for example remove, a possibly present time offset Δt by use of the determined at least one parameter. A corresponding controllable delay element as a separate piece of hardware may thus be dispensed with, so that costs may be saved.

FIG. 6 schematically shows a flow chart of the method for simulating an object for the sensor 14 for object detection.

In method step 60 the first signal S1, which has been emitted by the sensor 14, is received by the receiver RX and demodulated by the object simulator 10.

In method step 61 the receiver RX of the object simulator 10 outputs the first operating signal A1 which is generated by the demodulation.

In method step 62 the analysis unit 30, 32, 34 analyzes the first operating signal A1, and in method step 63 determines at least one parameter, for example a modulation parameter, of the first signal S1.

In an optional method step 64, the first operating signal A1 is changed to a second operating signal A2 in the object generator 22 as a function of at least one object to be simulated. Data concerning the at least one object to be simulated may be stored in the object simulator and/or supplied from the outside as object information 24.

The second signal S2 is generated as a function of at least one parameter in method step 65. The generation of the second signal may optionally take place as a function of the at least one object to be simulated. Data concerning the at least one object to be simulated may be stored in the object simulator and/or supplied from the outside as object information 24.

The sending of the second signal S2 takes place in method step 66. This second signal S2 represents a reflected first signal S1 on the simulated object or the simulated objects.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An object simulator for a sensor for object detection, the object simulator comprising:
a receiver that is configured to receive a first signal emitted by the sensor and to output a first operating signal that is a function of the first signal;
an analysis unit that is configured to analyze the first operating signal and to determine at least one parameter of the first signal; and
a transmitter that is configured to generate and send a second signal as a function of the at least one parameter and as a function of at least one object to be simulated,
wherein the second signal is provided for a reception by the sensor, and is provided such that it is perceivable by the sensor as a reflection of the first signal on the at least one object to be simulated.

2. The object simulator according to claim 1, wherein the first and second signals each have a high-frequency signal in the microwave range.

3. The object simulator according to claim 1, wherein the first signal is frequency-modulated, and wherein the at least one parameter pertains to the modulation of the first signal.

4. The object simulator according to claim 3, wherein the analysis unit is configured to determine at least one modulation parameter of the first signal, the at least one modulation parameter comprising a central frequency, a frequency range, a slope, a ramp duration, a ramp number, a frame duration, and/or a repetition rate.

5. The object simulator according to claim 1, wherein the analysis unit includes an analog circuit to analyze the first operating signal and/or for determining the at least one parameter.

6. The object simulator according to claim 1, wherein the analysis unit is configured to determine the at least one parameter using a spectrogram and/or using artificial intelligence.

7. The object simulator according to claim 1, wherein the analysis unit includes at least one gate array.

8. The object simulator according to claim 1, wherein the object simulator is configured to change the first operating signal with regard to the phase, the amplitude, and/or the frequency and to output it as the second signal.

9. The object simulator according to claim 1, wherein the object simulator includes an object generator that is configured to change the first operating signal to a second operating signal as a function of the object to be simulated, the receiver being configured to link the first signal to a first carrier signal for the first operating signal, the transmitter being configured to link the second operating signal to a second carrier signal for the second signal, and wherein generation of the second carrier signal is a function of the at least one parameter that is determined by the analysis unit and optionally of the object to be simulated.

10. A method for simulating an object for a sensor for object detection, the method comprising:
receiving a first signal emitted by the sensor;
outputting a first operating signal that is a function of the first signal;
analyzing the first operating signal;
determining at least one parameter of the first signal;
generating a second signal as a function of at least one object to be simulated and as a function of the at least one parameter; and
sending the second signal, the second signal being provided for the reception by the sensor, and is provided such that the second signal is perceivable by the sensor as a reflection of the first signal on the at least one object to be simulated.

11. The method according to claim 10, wherein the first and second signals each have a high-frequency signal in the microwave range.

12. The method according to claim 10, wherein the first signal is frequency-modulated, and the at least one parameter pertains to the modulation of the first signal.

13. The method according to claim 12, wherein at least one modulation parameter of the first signal is determined, wherein the at least one modulation parameter has a central frequency, a frequency range, a slope, a ramp duration, a ramp number, a frame duration, and/or a repetition rate.

14. The method according to claim 10, wherein the at least one parameter is determined using a spectrogram and/or using artificial intelligence.

15. The method according to claim 10, wherein the first operating signal is changed with regard to the phase, the amplitude, and/or the frequency and is sent as the second signal.

16. The method according to claim 10, wherein the first operating signal is changed to a second operating signal as a function of at least one object to be simulated, the first signal being linked to a first carrier signal for the first operating signal, the second operating signal being linked to a second carrier signal for the second signal, and wherein generation of the second carrier signal is a function of the at least one parameter that is determined and optionally of the object to be simulated.
